(19) United States
(12) Patent Application Publication
(10) Pub. No.: US 2002/0067860 A1
(43) Pub. Date: Jun. 6, 2002

(54) System, method and computer program product for improved lossless compression for bitmap fonts

(76) Inventors: Syed Aamer Azam, Union City, CA (US); Vladimir Stefanov Soskov, Castro Valley, CA (US)

Correspondence Address: SILICON VALLEY INTELLECTUAL PROPERTY GROUP, P.O. BOX 721120, SAN JOSE, CA, 95172-1120, US

(21) Appl. No.: 09/823,656

(22) Filed: Mar. 30, 2001

Related U.S. Application Data
(63) Continuation-in-part of application No. 09/686,439, filed on Oct. 10, 2000.

(51) Int. Cl. G06K 9/36

(52) U.S. Cl. 382/239

(57) ABSTRACT

A system, method and computer program product are provided for compression of characters. Initially, a selection is made between a plurality of compression formats based on an efficiency thereof. Thereafter, statistics are gathered on a plurality of characters based on the compression format that is selected. Further, an encoding procedure is executed on the characters utilizing the gathered statistics.

### RELATED APPLICATION(S)

The present application is a continuation-in-part of a parent application filed Oct. 10, 2000 under Ser. No. 09/686,439, which is incorporated herein by reference in its entirety.

### FIELD OF THE INVENTION

The present invention relates to compression algorithms, and more particularly to compressing textual data for storage and/or transmission utilizing a network.

### BACKGROUND OF THE INVENTION

When processing documents, computer systems are capable of displaying and printing character data in many different fonts. A font is a collection of characters and symbols of a particular style and size. Each font includes all of the letters, numbers, and other symbols which are generally required to produce a typical document in a language whose alphabet is part of the font.

A typeface is a particular design of type which can be rendered in any number of fonts which have particular typographer's point sizes. Typefaces are grouped in families. An example of a typeface family is Helvetica. (Helvetica is a trademark of Linotype-Hell AG and/or its subsidiaries.) Other families include Times and Shannon. (Times is a trademark of Linotype-Hell AG and/or its subsidiaries; Shannon is a trademark of Agfa Corp.) Helvetica Oblique is one typeface in the Helvetica family. Other typefaces in the family may include Helvetica Roman and Helvetica Italic. Within the Helvetica Oblique typeface, there is a separate font for each point size. That is, Helvetica Oblique 18 point, Helvetica Oblique 24 point, and Helvetica Oblique 36 point are all individual fonts in the Helvetica Oblique typeface. Fonts can be provided to computer systems in more than one version, for example, one for display monitors with 75 dots per inch resolution and one for 100 dpi monitors.

The format of the data used to represent fonts in computer systems depends upon the application program used to process the document and the mode in which the document is presented. If the application is to hard copy print the document, it may use outline font data to lay out the page for printing. Outline font data defines points in characters and how the points should be connected.

The application may lay out a page for display on a computer workstation monitor prior to printing. In that case, the application uses font metrics data to determine the amount of space in the document occupied by the text. Among other details, font metrics data defines the width of each character in the font, including composite characters, i.e., characters which are composed of more than one piece. This information is used by the application to set up the page for monitor display so that the displayed page represents as accurately as possible what a printed page will look like.

Fonts are presented to a computer display system in a bitmap data format. In this format, each character in the font occupies a rectangular grid or matrix of pixels. That is, a multiplicity of pixels is arranged in a series of same length rows, and each pixel is set to either an ON or an OFF state which is represented by a 1 or a 0 data bit, respectively. The pixels in the ON state provide an image of the font character in the grid or matrix of pixels.

Bitmap Fonts are particularly useful when only one glyph size is needed. Their advantage lies in the fact that no runtime rasterization of the image is needed since the bitmaps themselves are the actual raster images. They can also be useful when combined with a scalable font to provide manual hinting at small sizes.

While bitmaps are commonly used in the industry, there are problems when attempting to efficiently store such data in limited memory or transmit the same utilizing a network of limited bandwidth. There is therefore a need for improved techniques for compressing bitmap fonts.

### DISCLOSURE OF THE INVENTION

A system, method and computer program product are provided for compression of characters. Initially, a selection is made between a plurality of compression formats based on an efficiency thereof. Thereafter, statistics are gathered on a plurality of characters based on the compression format that is selected. Further, an encoding procedure is executed on the characters utilizing the gathered statistics.

In one embodiment of the present invention, the statistics may include information relating to a distance between vertical and horizontal components associated with the characters. In another embodiment, the statistics may include information relating to a bounding box surrounding each character. Moreover, the information may relate to a border area of the bounding box. In any case, the information may be stored in tables, and may be encoded utilizing Huffman encoding.

In another embodiment of the present invention, it may be determined whether the characters are Latin characters. Further, the Latin characters may be considered a combination of individual characters when encoded.

### BRIEF DESCRIPTION OF THE DRAWINGS

FIG. 1 illustrates a method for the compression of characters in accordance with one embodiment of the present invention;

FIG. 1A illustrates a bitmap showing various statistics that are collected for implementation of the first compression format;

FIGS. 1B through 1B-3 show the manner in which data is arranged during operation 114 of FIG. 1;

FIG. 2 illustrates a method for performing a first format for compression of the characters in accordance with FIG. 1;

FIG. 2A illustrates a bitmap with a character including a bounding box that surrounds the extremities of the character;

FIG. 2B illustrates a border area which is defined as the outermost pixels of the character that reside inside the bounding rectangle;

FIG. 2C illustrates an interior area of the bounding box and the manner in which it is divided into squares called units;

FIG. 2D illustrates information that is gathered associated with the statistics i1, j1, i2 and j2 shown in FIGS. 2A and 2B;

FIG. 2D-1 illustrates the manner in which the information of FIG. 2D may be unfolded it into a linear sequence;

FIG. 3 illustrates a method for performing a second format for compression of characters in accordance with FIG. 1;

FIG. 4 shows a representative hardware environment in which the foregoing methods of FIGS. 1-3 may be carried out;

FIG. 5 illustrates the manner in which the information of an exemplary embodiment of the first format is arranged; and

FIG. 6 is an explanatory diagram showing a code tree.

### DESCRIPTION OF THE PREFERRED EMBODIMENTS

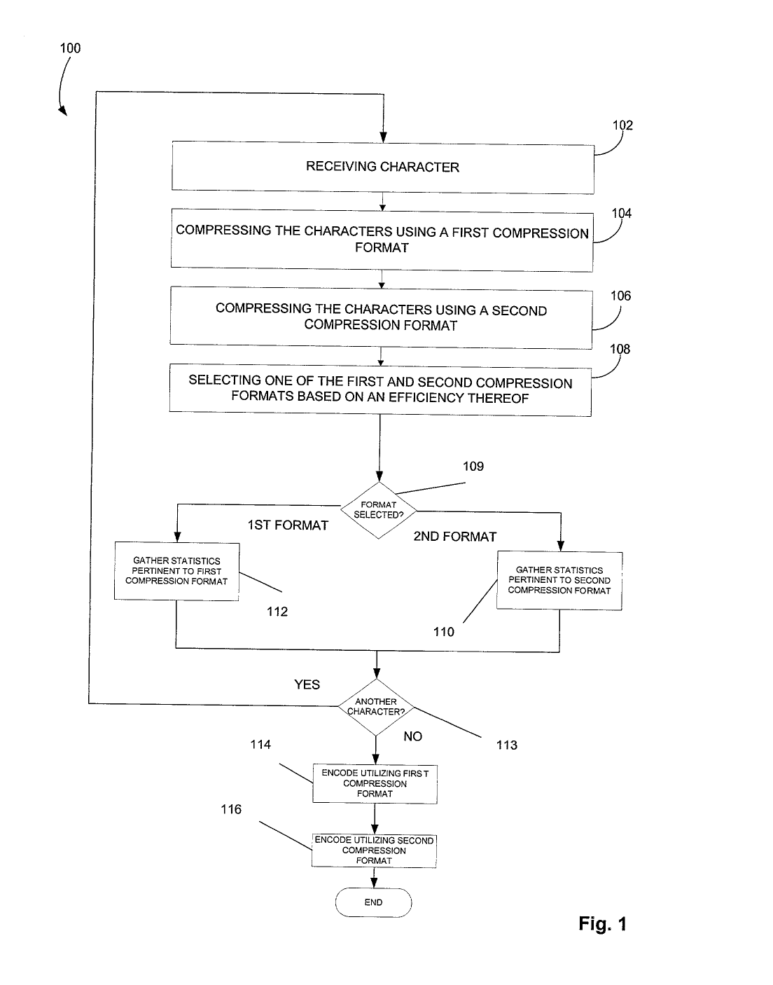

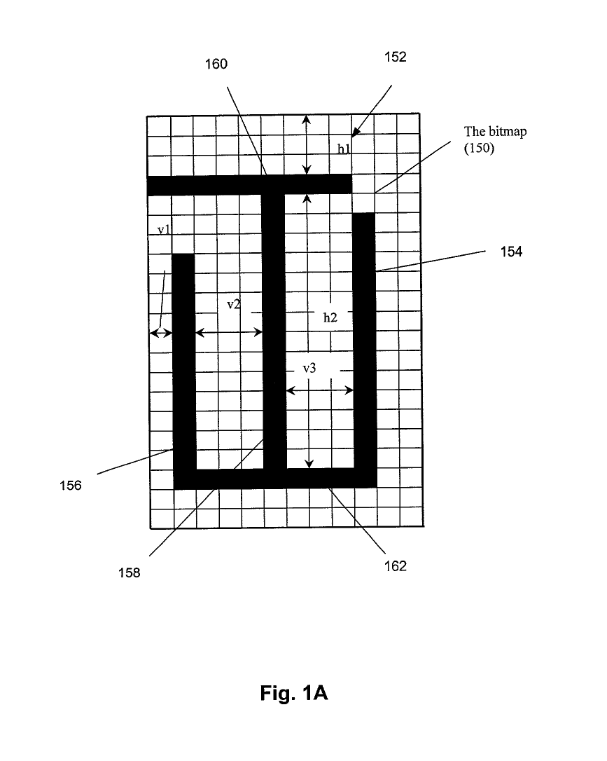

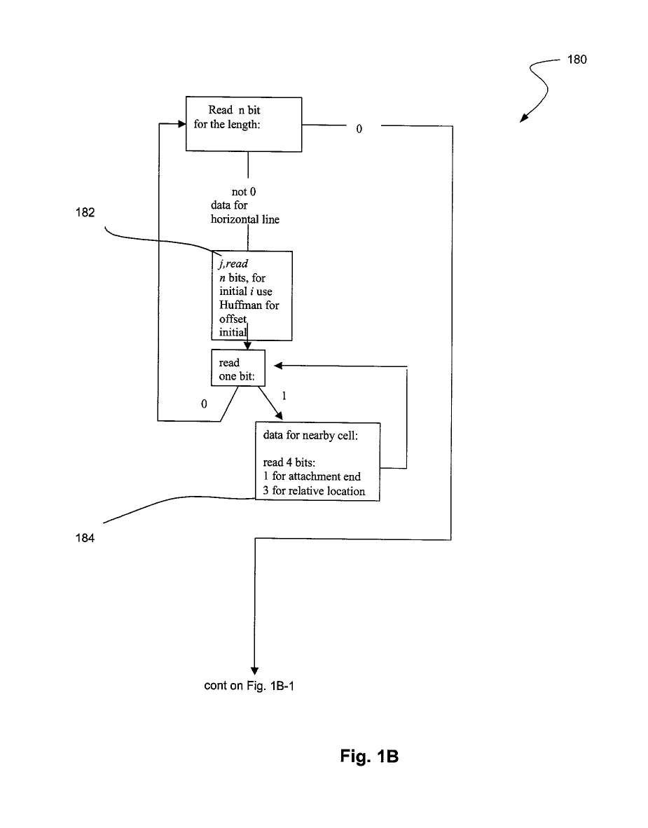

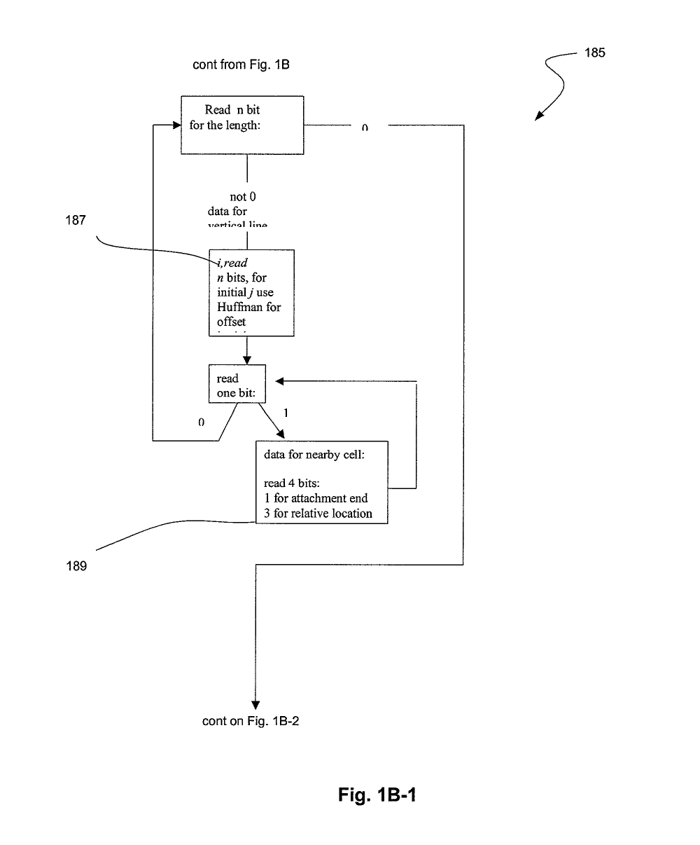

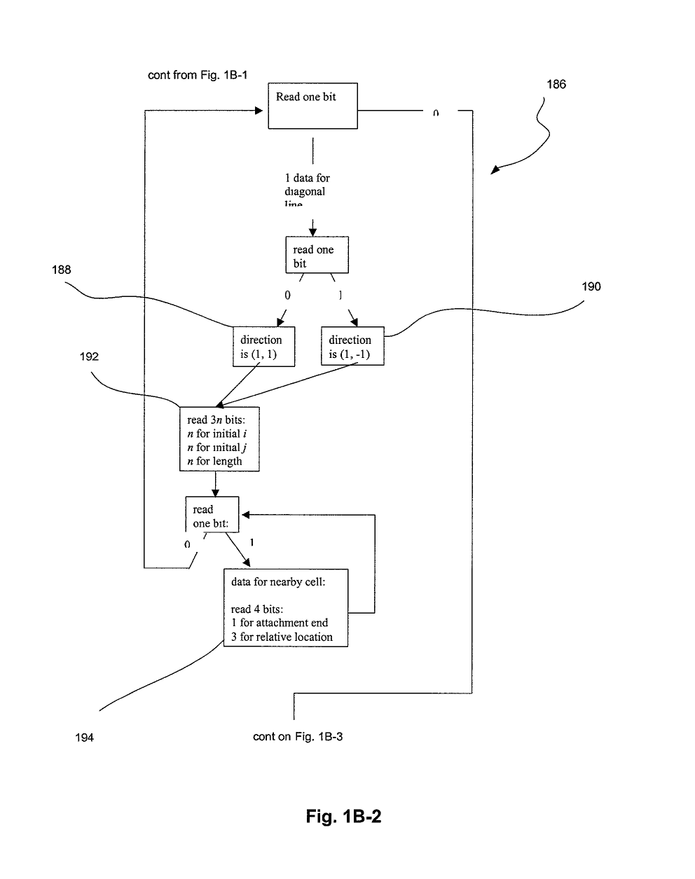

FIG. 1 illustrates a method 100 for the compression of characters. Such characters may take the form of alphabetical, numerical, or any other type of textual characters. Compression may be for the purpose of efficient storage and/or transmission of the characters, or any other desired purpose.

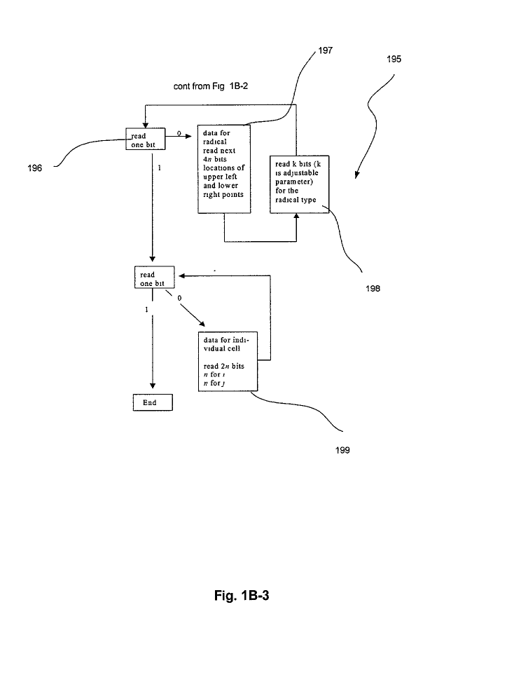

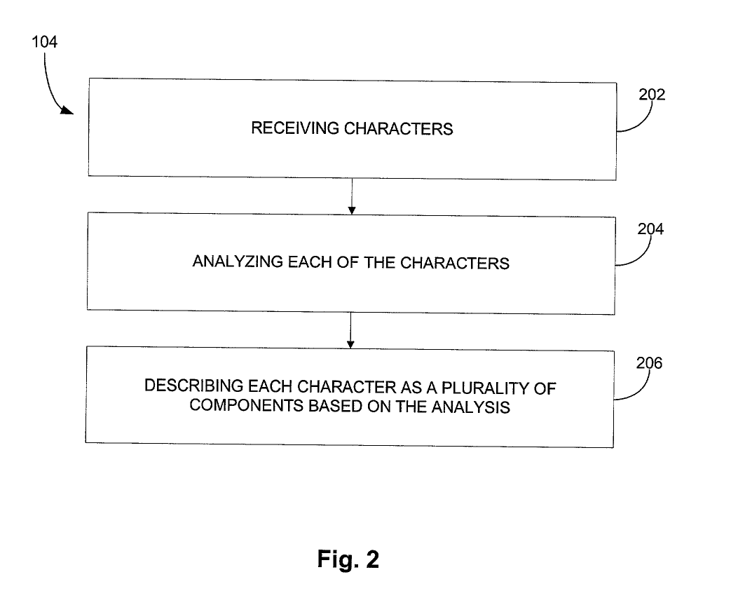

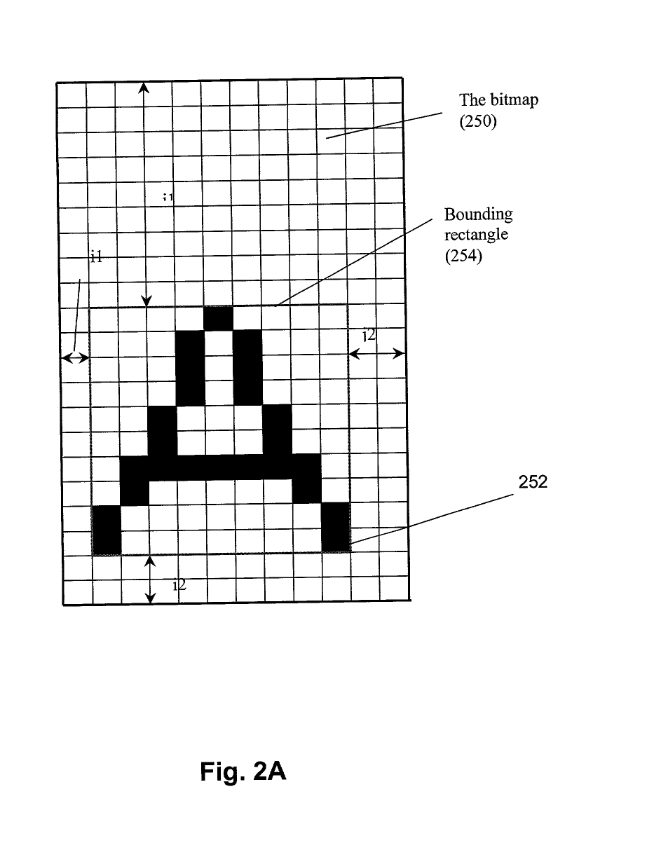

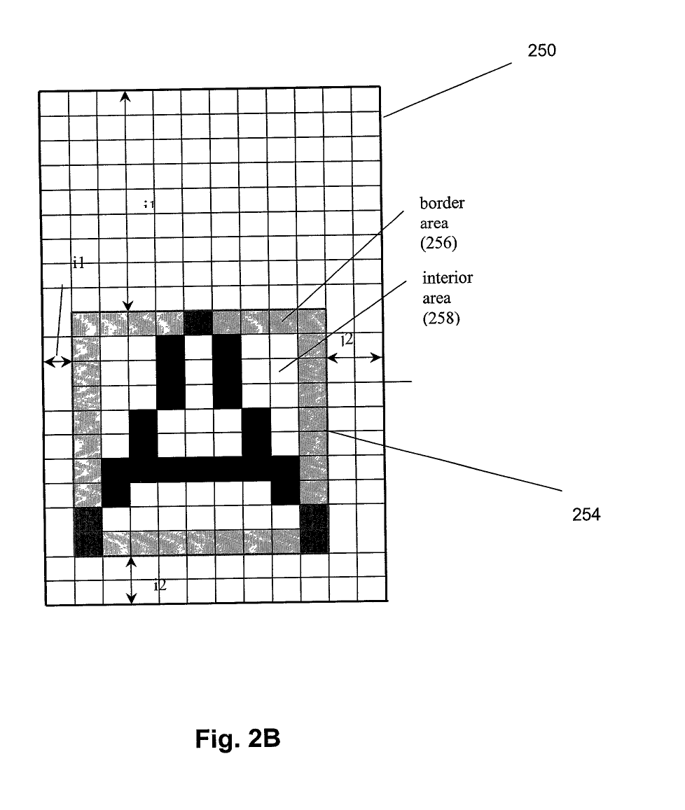

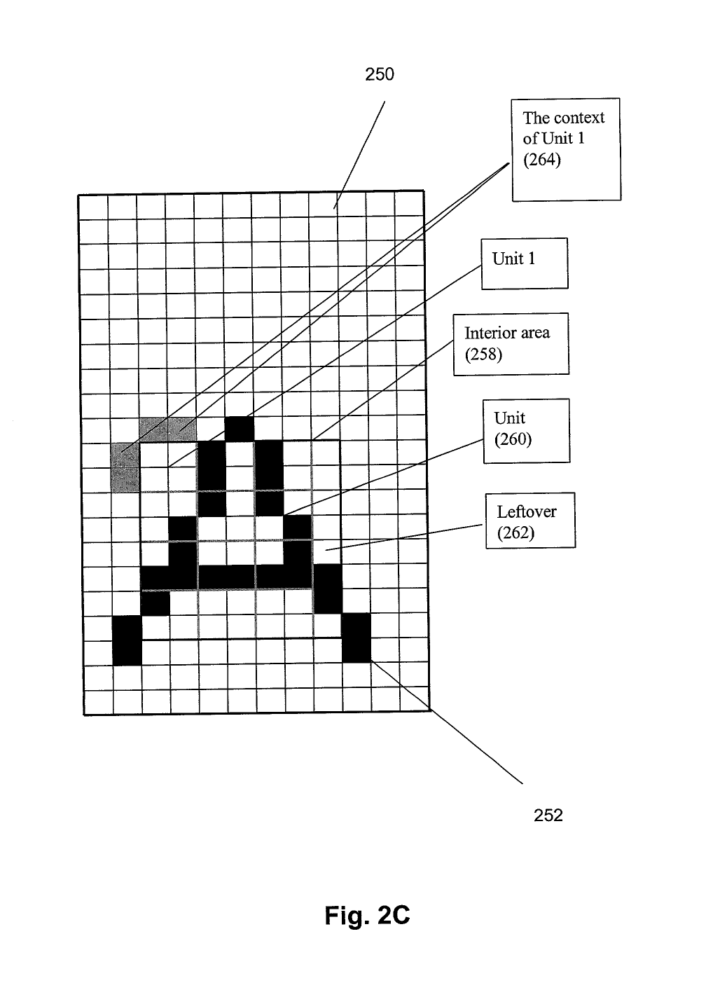

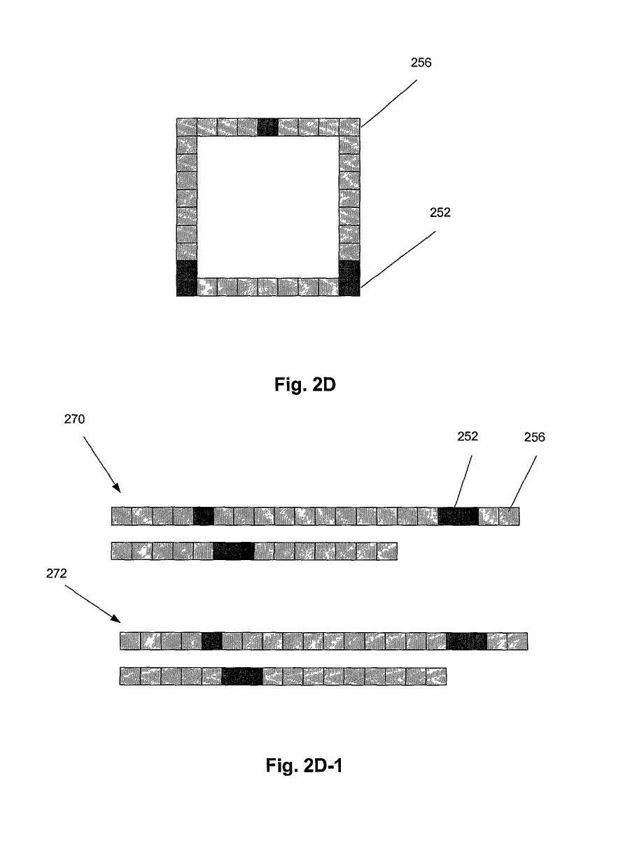

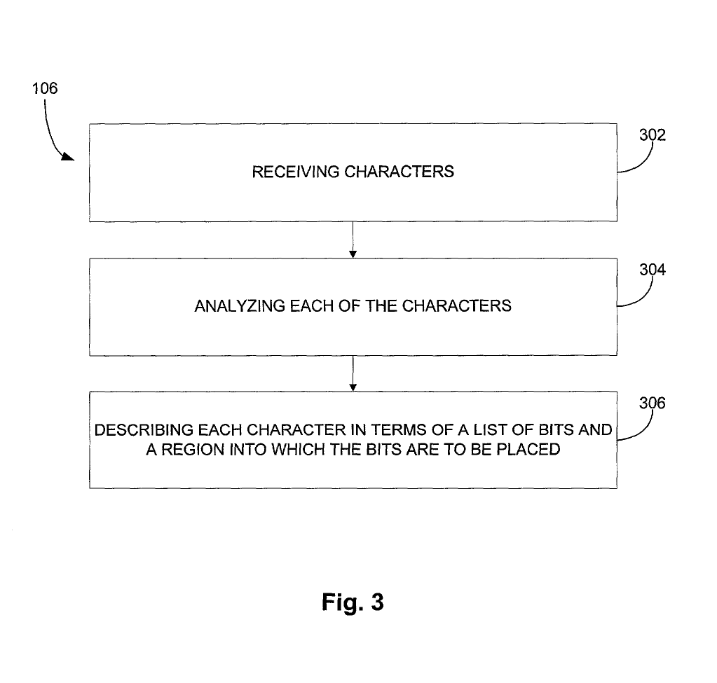

Initially, in operation 102, a group of characters are received which are to be compressed one at a time. Such characters are then compressed using a first compression format in operation 104. Thereafter, the characters are compressed again using a second compression format. See operation 106. The second compression format is different from the first compression format. More information on examples of first and second formats are set forth hereinafter during reference to FIGS. 2 and 3, respectively.

Next, one of the first and second compression formats is selected in operation 108. It should be noted that different sets of characters may be more effectively compressed by either the first or the second compression format. As such, the foregoing selection process of operation 108 is based on an efficiency of the compression formats. In order to determine such efficiency, the resultant compression formats may be compared. For instance, the compression format that generates a smaller compressed file may be selected.

As an option, it may also be determined as to whether the characters are Latin characters. If it is determined that the characters are of Latin origin, more than one bitmap may be used for characters such as “é” and “ê.” In particular, the images for “e,” ‘“,” and “ˆ ” may be handled separately, where the compression format is separately selected based on an ability of recognizing such character components. Next, each of the characters undergoes a separate statistics gathering procedure based on the selected compression format thereof. Note decision 109. If it is determined that the first compression format is selected in decision 109, a specific set of statistics is gathered from the appropriate file of characters in operation 112. Such statistics are pertinent to a modified version of the first compression format, as will be set forth in greater detail during reference to FIG. 1A.

On the other hand, if it is determined that the second compression format is selected in decision 109, a different set of statistics is gathered in operation 110. Such statistics are pertinent to a modified version of the second compression format, as will be set forth in greater detail during reference to FIG. 2A through FIG. 2D-1.

With continuing reference to FIG. 1, it is shown that it is determined in decision 113 as to whether all of the characters of the group have been received and processed in operations 102-112. If so, the characters are encoded in operation 114 with the modified first compression format utilizing the statistics gathered in operation 112. Further, the characters are encoded in operation 116 with the modified second compression format utilizing the statistics gathered in operation 110. More information with now be set forth regarding the statistics gathered in operations 110 and 112.

FIG. 1A illustrates a bitmap 150 showing various statistics 152 that are collected in operation 112 for the purpose of utilizing the modified first compression format, in accordance with operation 114 of FIG. 1. In particular, the statistics 152 include information or data relating to the distance between adjacent vertical and adjacent horizontal lines which make up each character 154. For example, the statistic v2 is a horizontal distance between a first vertical line 156 and a second vertical line 158 of the character 154, h2 is a vertical distance between a first horizontal line 160 and a second horizontal line 162 of the character 154, and so on. Table 1 illustrates vertical and horizontal line offset tables which may be used to gather and store the statistics 152. In the context of the present description, a frequency table for variable v and h is the table that indicates how many times each possible value of v and h appears, respectively.

TABLE 1

| | | | | | | | | | | | | | | | |
|---|---|---|---|---|---|---|---|---|---|---|---|---|---|---|---|
| 0 | 1 | 2 | 3 | 4 | 5 | 6 | 7 | 8 | 9 | 10 | 11 | 12 | 13 | 14 | 15 |

For v:

| | | | | | | | | | | | | | | | |
|---|---|---|---|---|---|---|---|---|---|---|---|---|---|---|---|
| 0 | 1 | 0 | 2 | 0 | 0 | 0 | 0 | 0 | 0 | 0 | 0 | 0 | 0 | 0 | 0 |

For h:

| | | | | | | | | | | | | | | | |
|---|---|---|---|---|---|---|---|---|---|---|---|---|---|---|---|
| 0 | 0 | 0 | 1 | 0 | 0 | 0 | 0 | 0 | 0 | 0 | 0 | 0 | 0 | 1 | 0 |

As shown, v has 0 values that are 0, 2 values that are 3, and so on.

FIG. 2 illustrates a method for performing a first format for compression of the characters, in accordance with operation 104 of FIG. 1. As shown, characters may be received in operation 202, after which each of the characters is analyzed in operation 204. Each character may then be described or represented as a plurality of components based on the analysis, as set forth in operation 206.

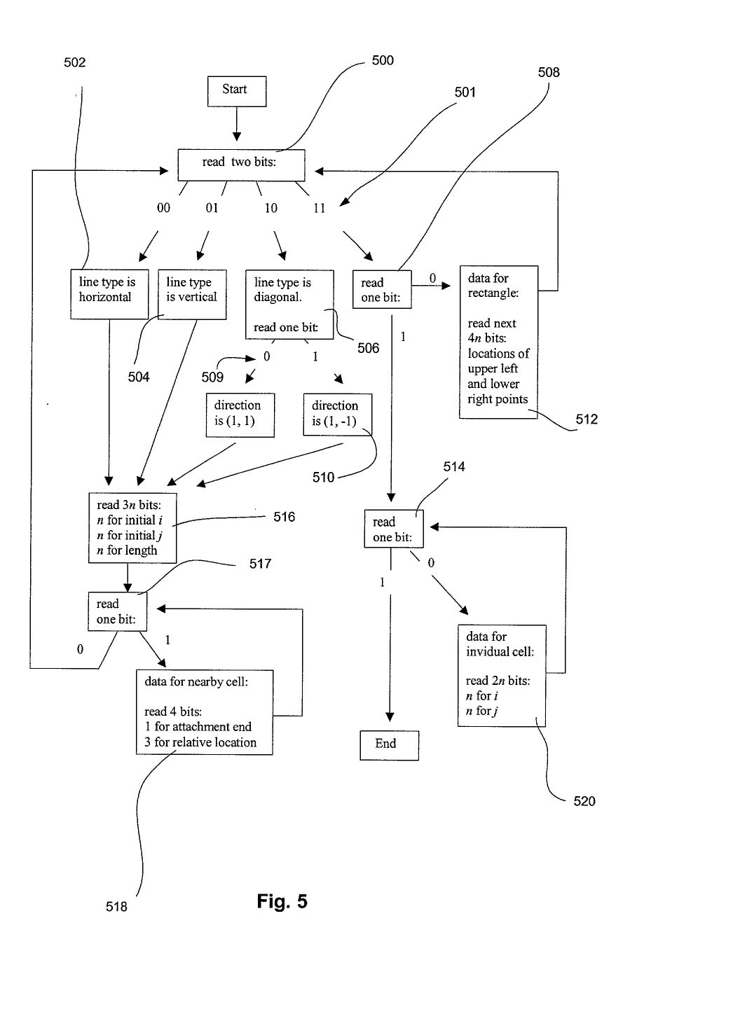

In one embodiment, the components may include a predetermined set. Such predetermined set of components may include (a) horizontal and vertical lines, (b) diagonal lines at +45 degrees and −45 degrees, (c) pixels attached to either end of lines, (d) individual pixels, and/or (e) rectangles. More information regarding an example of such will be set forth during reference to FIG. 5.

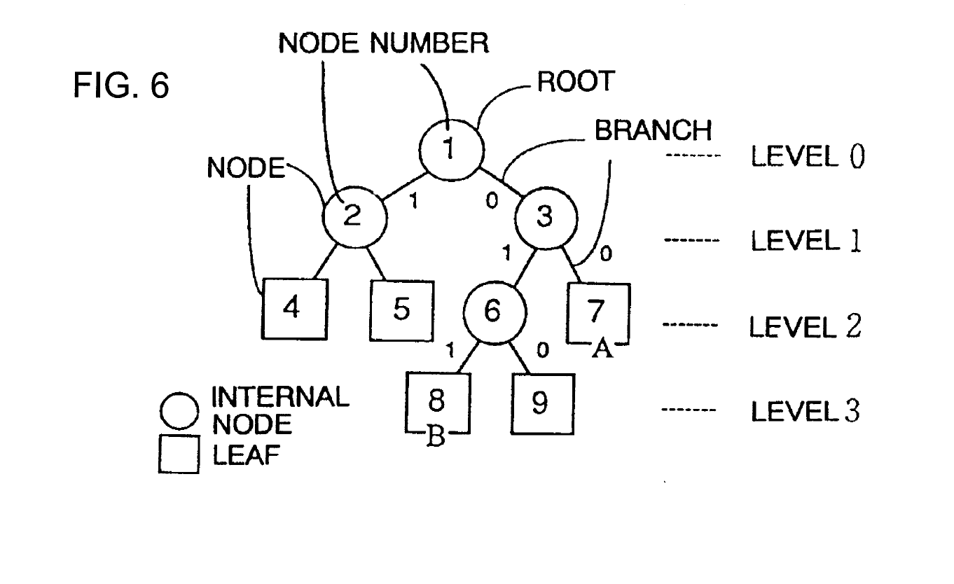

It should be noted that operation 114 of FIG. 1 is carried out in a similar manner as operation 104 of FIG. 1, with the exception of the use of Huffman coding and other techniques to encode the various statistics 152 of FIG. 1A. In particular, Huffman encoding is used to encode the distance between adjacent vertical lines and adjacent horizontal lines using the aforementioned frequency tables. More information regarding an example of such Huffman coding will be set forth hereinafter in greater detail during reference to FIG. 6. Further, FIGS. 1B through 1B-3 show the manner in which data is arranged during operation 114 of FIG. 1. This enables the more frequently occurring numbers to be represented with less space.

As shown in process 180 FIG. 1B, n bits of data are read to determine the length of a horizontal line in the glyph. If the length is non-zero, n bits are read to determine the x index (j) of the start of the horizontal line. To determine the y index (i), a Huffman code is used to give the distance down from the last horizontal line or from 0 for the first horizontal line. See operation 182. One more bit is then read to see if another small line can be attached to the end of the horizontal line. If so, it can be given in four (4) bits, one (1) bit for the attachment end and three (3) bits for relative location. See operation 184. When n bits of zeros are read for the horizontal line length, this signifies the current glyph contains no more horizontal lines, and vertical lines are now begun.

Vertical lines are arranged in the file, and read in the same way as horizontal during process 185 of FIG. 1B-1. As shown, n bits give the length, and a length of zero means move on to diagonal lines. A non-zero length requires that n bits be read for the i start position, and j bits be read for the offset from the previous j-value. See operation 187. One more bit is then read to determine if a small attaching line is included. If so, the process 185 follows the same format as operation 184 in process 180 for horizontal lines. If there is no attaching line, the process 185 continues onto the next vertical line.

After vertical lines for the glyph are all read, signified by a vertical line of length 0 (see operation 185 hereinabove), diagonal lines are read during process 186 as shown in FIG. 1B-2. Initially, one bit is read to determine whether data for a diagonal line follows or not. If a diagonal line follows, then one bit is read for the direction, which leads to either operation 188 or operation 190. As shown in operation 192, 2n bits are read for the starting x and y position of the line, and n more are read for the length. Diagonal lines can contain a small attaching line as well. As such, a trailing bit may be read followed by four (4) bits of extra data as for horizontal and vertical lines. When the diagonal lines are finished, signified by a zero in the first bit of diagonal line data, the process 186 moves on to radicals for the glyph.

The process 195 for reading radicals is shown in FIG. 1B-3. Initially, in operation 196, one bit is read to determine if the data is a radical. Next, 4n bits are read to determine where on the glyph to place the radical. See operation 197. After the radical box is positioned, k (k is adjustable) bits are read to determine which radical is to be drawn into the box. Note operation 198. The number k links back to a table of radicals where the data for the actual bitmap of the radical can be found. When there are no more radicals, signified by reading a “1” at operation 196, then one more bit is read after operation 196 to determine if there are any small corrections to the almost completed bitmap decompression. If so, these isolated points are read in 2n bits to determine location, and the corresponding bit on the bitmap is corrected. When the corrections are finished, signified by reading a “1” after operation 196, the bitmap decompression is ended.

FIG. 2A through FIG. 2D-1 illustrate the various statistics gathered in operation 110 for the purpose of utilizing the modified second compression format, in accordance with operation 116 of FIG. 1. In particular, FIGS. 2A-2C illustrate bitmapped characters showing defined entities that are useful in describing the statistics gathered for the second compression format.

FIG. 2A illustrates a bitmap 250 with a character 252 including a bounding box or rectangle 254 that surrounds the extremities of the character 252. The bounding rectangle 254 may be defined as the smallest rectangle that contains all pixels of the character 252.

As shown in FIG. 2A, i1 and i2 correspond to a distance between a top and bottom of the bitmap 250 and a top and bottom of the bounding rectangle 254, respectively. Further, j1 and j2 correspond to a distance between a left and right side of the bitmap 250 and a left and right side of the bounding rectangle 254, respectively.

FIG. 2B illustrates a border area 256 which is defined as the outermost pixels of the character 252 that reside inside the bounding rectangle 254. Further an interior area 258 is defined as the area inside the bounding rectangle 254 minus the border area 256.

FIG. 2C illustrates the interior area 258 and the manner in which it is divided into squares called units 260 with a size of two pixels from left to right, and from top to the bottom. An area in which the units 260 cannot fit in the interior area 258 is called leftover 262. The pixel on the top and on the left side of each unit is called a context 264 of that unit 260.

FIG. 2D illustrates information that is gathered associated with the statistics i1, j1, i2 and j2. As shown, the border area 256 is stored along with an indication as to which pixels of the border area 256 are populated by the character 252. FIG. 2D-1 illustrates the manner in which the information of FIG. 2D may be unfolded it into a linear sequence 270. If the length of the sequence is not divisable by four (4), white pixels may be added to the end as shown in the sequence 272.

The sequence 272 may be divided into pieces of four (4) pixels. For each piece-like binary representation of a number (0,1,0,0,3,0,6,0,0 for sequence 272), a corresponding frequency table is constructed. Table 1A illustrates such frequency table for sequence 272 of FIG. 2D-1.

TABLE 1A

| 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| 6 | 1 | 0 | 1 | 0 | 0 | 1 | 0 | 0 | 0 | 0 | 0 | 0 | 0 | 0 | 0 |

Similarly, the units 260 and their contexts 264 may be observed as numbers in the range [0,16) such that sixteen frequency tables are provided for every possible value of the contexts 264. The definition of this notation for a range of numbers is that the set begins with the first number, which is included in the set, and ends just before the second number. For every unit, a one (1) is added in the corresponding place in Table 1A for its context 264.

FIG. 3 illustrates a method for utilizing a second format for compression of characters. Note operation 106 of FIG. 1. Such method initially includes receiving characters, as indicated in operation 302. Further, each of the characters is analyzed in operation 304. Each character is then described based on the analysis of operation 304. Such description may be in terms of a region into which bits are to be placed and a list of bits. See operation 306. As an option, the region may include a rectangle. Further, a position of the rectangle may be indicated with the description of each character. It should be noted that the bits of the list fill the rectangle. More information regarding an example of such second compression format will be set forth in greater detail hereinafter.

It should be noted that operation 116 of FIG. 1 is carried out in a similar manner as operation 106 of FIG. 1, with the exception of the use of Huffman coding to encode the various statistics set forth during reference to FIGS. 2A through 2D-1. In particular, i1, j1, i2, j2, the border area 258 and the units 260 may be stored, along with any other desired statistics. Further, the leftover 262 may also be stored in a list of bits. More information regarding an example of such Huffman coding will be set forth hereinafter in greater detail.

In operation 106 of FIG. 1 which contains no Huffman coding, large areas in the bitmap 250 are not compressed. They are simply stored. The major improvement in operation 116 is to further compress these regions using the principles of units 260 and contexts 264, as shown in FIG. 2C. For each context 264, there are marked trends in the types of units that occur. For example, if the context 264 has all ones then one often finds all zeros in the unit because the presence of the ones most likely indicates that there were two lines nearby and the unit is then a blank area near the lines. It is important to note that the idea of a context 264 is allow the present invention achieve higher compression. This makes it possible to create a small frequency table to effect the compression. In other words, it is possible to avoid larger frequency tables in this way.

As mentioned earlier, the region to be compressed cannot always be decomposed into an integer number of units. This occurs when the region has an odd width, for example. Statistics regarding this remaining area, or leftover area 262, may be stored as a sequence of bits.

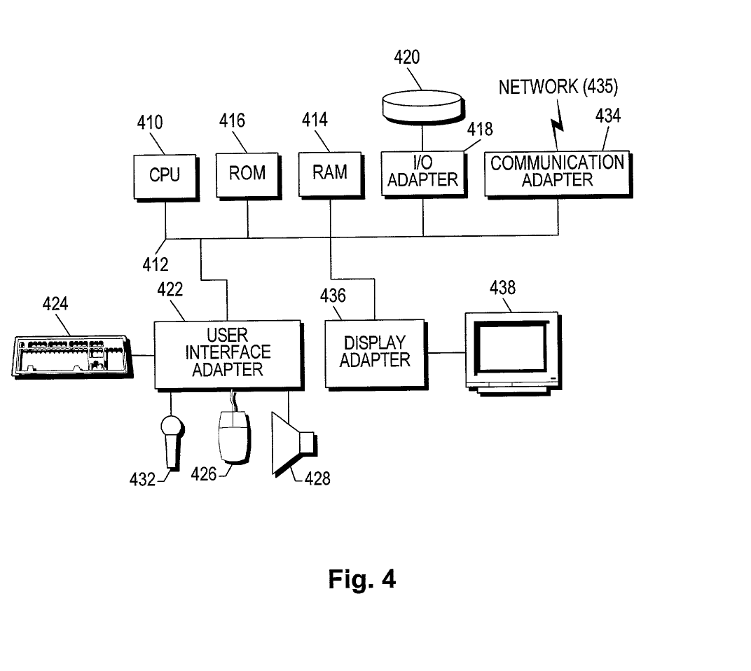

FIG. 4 shows a representative hardware environment in which the foregoing methods of FIGS. 1-3 may be carried out. Such figure illustrates a typical hardware configuration of a workstation in accordance with a preferred embodiment having a central processing unit 410, such as a microprocessor, and a number of other units interconnected via a system bus 412.

The workstation shown in FIG. 4 includes a Random Access Memory (RAM) 414, Read Only Memory (ROM) 416, an I/O adapter 418 for connecting peripheral devices such as disk storage units 420 to the bus 412, a user interface adapter 422 for connecting a keyboard 424, a mouse 426, a speaker 428, a microphone 432, and/or other user interface devices such as a touch screen (not shown) to the bus 412, communication adapter 434 for connecting the workstation to a communication network 435 (e.g., a data processing network) and a display adapter 436 for connecting the bus 412 to a display device 438.

The workstation may have resident thereon an operating system such as the Microsoft Windows NT or Windows/95 Operating System (OS), the IBM OS/2 operating system, the MAC OS, or UNIX operating system. It will be appreciated that a preferred embodiment may also be implemented on platforms and operating systems other than those mentioned. A preferred embodiment may be written using JAVA, C, and/or C++ language, or other programming languages, along with an object oriented programming methodology. Object oriented programming (OOP) has become increasingly used to develop complex applications.

First Format

As mentioned earlier, the present invention employs at least two formats for compressing bitmap fonts. For a given bitmap, one or the other of these two formats may be the more efficient. Thus, at the compression stage, both formats are tried and the choice of the format used may be indicated by a bit in the compressed file.

An example of the first format represented in FIG. 2 will now be set forth in greater detail. The first format is based on the idea of describing a character in terms of components. The format uses a basis set that is shown in Table 1B.

### Table 1B

horizontal and vertical lines

diagonal lines at +45° and −45°.

pixels attached to either end of lines

individual pixels

rectangles

FIG. 5 illustrates the data structure in which the information of the first format associated with operation 104 of FIG. 1 is arranged. Such information includes a list of lines (with possible attached pixels) and rectangles. Initially, in operation 500, a first two bits 501 of an entry in the list are read to indicate horizontal 502, vertical 504, diagonal 506, or “other” components 508.

If the line is diagonal, a further bit 509 specifies its slope, or direction 510. The “other” component possibility is subdivided into two further possibilities by a bit: a rectangle 512 or the end of the list 514.

The next information for the lines is a set of 3n bits 516. Here, the symbol n is introduced to denote the number of bits that are used to specify one of the position coordinates that is used within the bitmap. For example, for a 16×16 bitmap, n=4 would be used. The coordinates are often called i and j. The first one, i, is the number of steps down from the top of the bitmap, and the second one, j, is the number of steps to the right, starting from the left edge. The 3n bits just mentioned specify the two coordinates of the starting point of the line and its length.

Following this information, there is the possibility of using another bit 517 to describe further pixels as “extensions,” or “nearby pixels.” See 518. For such a pixel, one bit is used to indicate the end of the line to which it is attached, and three further bits specify which of the eight possible displacement vectors (with length less than two) is to be used relative to the end of the line.

The other entries in this list are rectangles. See 512. Rectangles are described with 4n bits. After this list comes a list of individual pixels 520. These pixels are not close enough to a line to be included in the previous list. Each of these requires 2n bits.

Second Format

As set forth during reference to FIG. 3, the second format is based on the idea of describing a character in terms of a region into which bits are to be placed and a list of bits. A version of this format associated with operation 106 of FIG. 1 will now be set forth. First, four coordinates are specified including coordinates of the upper left and the lower right vertices of a rectangle. All of the bits in the list of bits are to be filled into this rectangle.

All pixels outside the rectangle are zero, with one exception. For most fonts, many of the first columns that are not all zero have exactly one (1). These can be described with a single position coordinate, the location of the solitary 1. The next feature of this version of the format is the optional specification of a forbidden rectangular region within the rectangle already specified. If an empty rectangle can be found with an area of more than 4n, then it is useful to use this option. Following this information is a list of bits that are to be filled into the specified space.

For a given bitmap, further compression of the above mentioned data may be achieved if the dimensions of the bitmap are not powers of two. For example, if a 16×12 bitmap is provided, then a set of numbers will result in the range from zero to eleven. One way to compress a list of such numbers is to use them as digits to form a base-12 number (in this example) and to store this number.

Another way to achieve further compression is to use a scheme that omits predetermined binary digits. For example, the number nine has the binary representation 1001. However, when writing these bits from left to right, it is already known that the bit following the initial 1 must be a 0, because the numbers are represented in the range from zero to eleven. Thus, one arrives at a code where zero is represented by 0000, one is represented by 0001, etc., up to seven being represented by 0111. The abovementioned 0 is dropped from the representations of eight, nine, ten and eleven.

A further embodiment that may be implemented exists since the numbers that are encountered have an average that is less than half of the range of the coordinate. In such case, one may store eleven minus the coordinate, in the language of this example.

Having described the foregoing formats, the separate issue may be addressed of representing a bitmap efficiently using these formats. For the version of the second format described above, the representation is unique up to choices of inner rectangles that happen to have the same maximal area. It is easy to achieve optimal compression within the framework of this format.

The situation with the first format is more complicated. The case of representing a pound sign (#) may be considered to illustrate this. It is usually advantageous to identify rectangles and use them in the compressed representation. However, in this case, it may still be necessary to include the four lines to complete the character, so the inclusion of the rectangle in the list of elements is not necessary.

Another example is that some characters have large solid regions and therefore contain a large number of rectangles. This number scales as the fourth power of the size of such a region. A procedure that may be used for the first format is as follows: A list is first generated of all rectangles with edges longer than one contained in the character. Next, lists of lines contained in the character are generated, starting with longer lengths, with the property that lines contained in a single longer line (which must then have the same direction) are not included.

Then, a copy of the bitmap is obtained so that rectangles may be removed if such removal will eliminate more than two pixels. Next, lines are removed, starting with the longer ones, if such removal will eliminate more than one pixel. In a separate copy of the bitmap, the same removals may be carried out, plus the removal of “nearby pixels,” as defined above. This is not necessarily performed in the first copy because pixels may be chosen as such extensions even though they could be more efficiently be treated with a subsequent line removal. An example of this effect is provided by a character that has two straight lines that meet at a right angle.

This process continues down to a line length of two. Then, the remaining pixels in the second copy of the bitmap are used to define a list of individual pixels, as defined above. The pixels where the two copies differ are attached to lines as extension pixels.

As mentioned earlier, operations 114 and 116 of FIG. 1 is carried out in a similar manner as operations 104 and 106 of FIG. 1, respectively, with the exception of the use of Huffman coding to encode the various statistics. Huffman encoding is used for encoding the variables represented by the frequency tables. Using this table, a Huffman may be used to build a tree. From this tree, a code is achieved for each value.

Before going into a detailed description of the Huffman coding, a code tree (defined as a data structure) used when generating the Huffman codes will be explained.

FIG. 6 illustrates one example of a code tree. Nodes are points marked with a circle and a square. A line segment connecting the nodes is called a “branch”. The node located in the highest position is called a “root”. Further, an under node Y connected via the “branch” to a certain node X is termed a “child” of the node X. Further, the node X is referred to as a “parent” of the node Y. A node having no “child” is called a “leaf”, and a particular character corresponds to each “leaf”. Further, the nodes excluding the “leaves” are referred to as “internal nodes”, and the number of “branches” from the “root” down to each “node” is called a level.

When encoded by use of the code tree, a path extending from the “root” down to a target “leaf” (corresponding to a character to be encoded) is outputted as a code. More specifically, “1” is outputted when branching off to the left from each of the nodes from the “root” down to a target “leaf”, while “0” is outputted when branching off to the right. For instance, in the code tree illustrated in FIG. 6, a code “00” is outputted for a character A corresponding to a “leaf” of a node number 7, and a code “011” is outputted for a character B corresponding to a “leaf” of a node number 8.

When decoded, a character is outputted which corresponds to a “leaf” which is reached by tracing the respective nodes from the “root” in accordance with a value of each bit of code defined as a target for decoding.

According to the Huffman coding, the above-described code tree is generated by the following procedures (called a Huffman algorithm).

(1) Leaves (nodes) corresponding to the individual characters are prepared, and the frequency of occurrence of the characters corresponding to the respective leaves are recorded.

(2) One new node is created for two nodes having the minimum occurrence frequency, and this created node is connected via branches to the two nodes. Further, a sum of the occurrence frequencies of the two nodes connected via the branches is recorded as an occurrence frequency of the newly created node.

(3) The processing set forth in item (2) is executed for the remaining nodes, i.e. the nodes not having parents, until the number of remaining nodes becomes 1.

In the code tree generated by such procedures, it follows that a code is allocated to each character with a code length which is inversely proportional to the occurrence frequency of the character. Therefore, when the coding is performed by use of the code tree, it follows that the data can be compressed.

According to the static coding, normally, the occurrence frequency of each character appearing within the data to be encoded is first counted and the code tree is created based on the counted occurrence frequency in the above-described procedures. Next, the relevant data is encoded by use of the code tree, and an encoded result is outputted as a piece of encoded data together with data representing a configuration of the code tree. That is, code trees having leaves which correspond to the characters to be encoded are prepared according to the static coding and the coding is then executed using those code trees. Then, on the decoding side, decoding is carried out by use of the code trees outputted together with the codes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for compression of characters, comprising the steps of:
(a) selecting between a plurality of compression formats based on an efficiency thereof;
(b) gathering statistics on a plurality of characters based on the compression format that is selected; and
(c) executing an encoding procedure on the characters utilizing the gathered statistics.

2. The method as recited in claim 1, wherein the statistics include information relating to a distance between vertical and horizontal components associated with the characters.

3. The method as recited in claim 1, wherein the information is stored in tables.

4. The method as recited in claim 1, wherein the statistics include information relating to a bounding box surrounding each character.

5. The method as recited in claim 4, wherein the information relates to a border area of the bounding box.

6. The method as recited in claim 1, wherein the statistics are encoded utilizing Huffman encoding.

7. The method as recited in claim 1, and further comprising the step of determining whether the characters are Latin characters.

8. The method as recited in claim 7, and further comprising the step of considering the Latin characters as a combination of individual characters.

9. A computer program product for compression of characters, comprising:
(a) computer code for selecting between a plurality of compression formats based on an efficiency thereof,
(b) computer code for gathering statistics on a plurality of characters based on the compression format that is selected; and
(c) computer code for executing an encoding procedure on the characters utilizing the gathered statistics.

10. The computer program product as recited in claim 9, wherein the statistics include information relating to a distance between vertical and horizontal components associated with the characters.

11. The computer program product as recited in claim 9, wherein the information is stored in tables.

12. The computer program product as recited in claim 9, wherein the statistics include information relating to a bounding box surrounding each character.

13. The computer program product as recited in claim 12, wherein the information relates to a border area of the bounding box.

14. The computer program product as recited in claim 9, wherein the statistics are encoded utilizing Huffman encoding.

15. The computer program product as recited in claim 9, and further comprising computer code for determining whether the characters are Latin characters.

16. The computer program product as recited in claim 15, and further comprising computer code for considering the Latin characters as a combination of individual characters.

17. A system for compression of characters, comprising:
(a) logic for selecting between a plurality of compression formats based on an efficiency thereof;
(b) logic for gathering statistics on a plurality of characters based on the compression format that is selected; and
(c) logic for executing an encoding procedure on the characters utilizing the gathered statistics.

18. A method for compression of characters, comprising the steps of:
(a) gathering statistics associated with a plurality of characters; and
(b) executing an encoding procedure on the characters utilizing the gathered statistics;
(c) wherein the statistics are encoded using Huffman encoding.

19. The method as recited in claim 18, wherein the statistics include information relating to a distance between vertical and horizontal components associated with the characters.

20. The method as recited in claim 19, wherein the statistics include a context.

21. The method as recited in claim 18, wherein the statistics include information relating to a bounding box surrounding each character.

22. The method as recited in claim 21, wherein the information relates to a border area of the bounding box.

23. A computer program product for compression of characters, comprising:
(a) computer code for gathering statistics associated with a plurality of characters; and
(b) computer code for executing an encoding procedure on the characters utilizing the gathered statistics;
(c) wherein the statistics are encoded using Huffman encoding.
